(19) United States
(12) Patent Application Publication
(10) Pub. No.: US 2025/0105610 A1
(43) Pub. Date: Mar. 27, 2025

(54) ANCHORING SYSTEMS FOR USE ON TELECOMMUNICATION STRUCTURES

(71) Applicant: Outdoor Wireless Networks LLC, Claremont, NC (US)

(72) Inventors: Yu Wu, Suzhou (CN); Bin Ai, Suzhou (CN); Jared Haines, Rocky City Falls, NY (US); Edgar B.K.A. Beshay, Allen, TX (US)

(21) Appl. No.: 18/951,857

(22) Filed: Nov. 19, 2024

Related U.S. Application Data
(63) Continuation-in-part of application No. PCT/CN2023/070034, filed on Jan. 3, 2023.
(60) Provisional application No. 63/606,263, filed on Dec. 5, 2023.
(60) Provisional application No. 63/618,641, filed on Jan. 8, 2024.

(51) Int. Cl. H02G 3/32; H02G 3/04

(52) U.S. Cl. CPC H02G 3/32; H02G 3/0456

(57) ABSTRACT

The present application is directed anchoring systems for cables on a monopole. An anchoring system includes a base module having a plurality of clamping members. Each clamping member includes an upper plate having a plurality of apertures, a lower plate coupled to the upper plate by two or more support beams, each support beam having an aperture configured to receive a threaded member, and a hollow pipe secured between the upper and lower plates. An eyebolt is received through the hollow pipe and secured to the clamping member. Adjacent clamping members are connected by the threaded members that engage with mating threaded connectors to allow for decreased or increased spacing between the clamping members to engage the monopole therebetween, and each eyebolt is configured to engage one or more hoisting grips that support cables being routed inside and/or outside of the monopole. Alternative anchoring systems are also described.

### RELATED APPLICATION(S)

The present application is a continuation-in-part of International Application Serial No. PCT/CN2023/070034, filed Jan. 3, 2023. The present application also claims priority from and the benefit of U.S. Provisional Patent Application Ser. No. 63/606,263, filed Dec. 5, 2023, and U.S. Provisional Patent Application Ser. No. 63/618,641, filed Jan. 8, 2024. The disclosures of each application are hereby incorporated herein in full.

### FIELD

The present invention relates to telecommunications equipment, and in particular, an anchoring system for cables on a monopole, guyed antenna tower, and cable ladder.

### BACKGROUND

With the addition of more legacy coax cables, as well as the substantially heavier hybrid cables to monopoles, the current anchors (e.g., J-bolt anchors) that secure these cables to the monopole may have their capacity exceeded, resulting in the anchors failing. These cables are usually routed inside and outside of the monopole (see, e.g., FIGS. 1A-1D) and there is currently no universal anchor device in the industry that can simultaneously lift and support internal and external cables. In addition, in some instances, accessories for monopoles, guyed antenna towers, and antenna masts (e.g., ring mounts and cable ladders) are being improperly used in the field to support these heavier cables, which is resulting in damage to these accessories (see, e.g., FIGS. 16A-16B). There may be a desire for a new anchoring system to support these heavier cables on the monopoles, guyed antenna towers, and cable ladders.

### SUMMARY

A first aspect of the present invention is directed to an anchoring system for cables on a monopole. The anchoring system includes a base module having a plurality of clamping members. Each clamping member includes an upper plate having a plurality of apertures, a lower plate coupled to the upper plate by two or more support beams, each support beam having an aperture configured to receive a threaded member, and a hollow pipe secured between the upper and lower plates. At least a portion of an eyebolt is received through the hollow pipe and secured to the clamping member. Adjacent clamping members are connected by the threaded members that engage with mating threaded connectors such that the threaded connectors may be threaded onto and off of the threaded members to decrease or increase spacing between the clamping members to engage the monopole therebetween, and each eyebolt is configured to engage one or more hoisting grips that support cables being routed inside and/or outside of the monopole.

Another aspect of the present invention is directed to an anchoring system for cables on a monopole. The anchoring system includes a base module and an expansion module coupled to the base module. The base module has a plurality of clamping members. Each clamping member includes an upper plate having a plurality of apertures, a lower plate coupled to the upper plate by two or more support beams, each support beam having an aperture configured to receive a threaded member, and a hollow pipe is secured between the upper and lower plates. At least a portion of an eyebolt is received through the hollow pipe and secured to the clamping member. Adjacent clamping members are connected by the threaded members that engage with mating threaded connectors such that the threaded connectors may be threaded onto and off of the threaded members to decrease or increase spacing between the clamping members to engage the monopole therebetween. One or more of the plurality of apertures in the upper plate of a clamping member are configured to receive a fastener to secure the expansion module to the base module. The expansion module also includes an eyebolt, each eyebolt is configured to engage one or more hoisting grips that support cables being routed inside and/or outside of the monopole.

Another aspect of the present invention is directed to an anchoring system for cables on a monopole. The anchoring system includes a base module and an expansion module coupled to the base module. The base module has a plurality of clamping members. Each clamping member includes an upper plate having a plurality of apertures, a lower plate coupled to the upper plate by two or more support beams, each support beam having an aperture configured to receive a threaded member, and a hollow pipe is secured between the upper and lower plates. At least a portion of an eyebolt is received through the hollow pipe and secured to the clamping member. Adjacent clamping members are connected by the threaded members that engage with mating threaded connectors such that the threaded connectors may be threaded onto and off of the threaded members to decrease or increase spacing between the clamping members to engage the monopole therebetween. The expansion module includes three L-shaped brackets and an expansion plate. Each L-shaped bracket has a main member and an arm member coupled thereto and extending inwardly from the main member such that each of the arm members are positioned over a top of the monopole, and each main member is configured to be secured to a respective clamping member of the base module. The expansion plate configured to be secured to each arm of the L-shaped brackets and includes a central aperture with an eyebolt received therethrough and secured to the expansion plate. One or more of the plurality of apertures in the upper plate of a clamping member are configured to receive a fastener to secure the expansion module to the base module, and each eyebolt is configured to engage one or more hoisting grips that support cables being routed inside and/or outside of the monopole.

Another aspect of the present invention is directed to an anchoring system for cables routed up a guyed antenna tower. The anchoring system includes a main support beam, two mounting brackets, each mounting bracket affixed to an opposing end of the main support beam, the mounting brackets configured to secure the anchoring system to the guyed antenna tower, and at least one eyebolt affixed to the main support beam. The at least one eyebolt is configured to engage one or more hoisting grips that support cables being routed up the guyed antenna tower.

Another aspect of the present invention is directed to an anchoring system for a cable ladder extending up an antenna mast. The cable ladder includes a pair of support beams extending parallel to each other and has a plurality of cable beams extending therebetween. The cable anchoring system includes a main support beam having at least two apertures which each align with a respective aperture in one of the plurality of cable beams, and at least one eyebolt affixed to the main support beam. The aligned apertures are configured to receive a respective fastener to secure the anchoring system to the cable ladder, and the at least one eyebolt is configured to engage one or more hoisting grips that support cables being routed up the antenna mast.

Another aspect of the present invention is directed to an anchoring system for a ring mount. The anchoring system includes a base module including a plurality of clamping members, each clamping member comprising an upper plate and a lower plate with adjacent clamping members connected by threaded members configured to decrease or increase spacing between the clamping members to engage a mounting structure; and one or more anchoring members coupled to the lower plate of at least one of the clamping members. The base module is configured to secure a platform assembly to the mounting structure.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIGS. 1A-1D illustrate examples of how cables are currently routed inside (FIG. 1A) and outside (FIGS. 1B-1D) of a monopole.

FIG. 2A is a top perspective view of an anchoring system adapted for use on a monopole according to embodiments of the present invention.

FIG. 2B is a side view of the anchoring system of FIG. 2A.

FIG. 3 is a top perspective view of the base module of the anchoring system of FIG. 2A according to embodiments of the present invention.

FIG. 4 is a top perspective view of the expansion module of the anchoring system of FIG. 2A according to embodiments of the present invention.

FIG. 5A is a side cross-section view of an exemplary eyebolt that may be used with the anchoring systems of the present invention.

FIG. 5B is an enlarged side cross-section view of another exemplary eyebolt that may be used with the anchoring system of the present invention received through the hollow pipe of the clamping member of the base member of FIG. 3.

FIGS. 6A-6C illustrate exemplary configurations for the anchoring system of FIG. 2A according to embodiments of the present invention.

FIG. 6D is a perspective view of the anchoring system of FIG. 6C with a hoisting grip and cable secured to the anchoring system according to embodiments of the present invention.

FIGS. 7A-7B are top views of the anchoring system of FIG. 2A illustrating the anchoring system being adjustable to accommodate different diameter monopoles according to embodiments of the present invention.

FIG. 8A is a top perspective view of an alternative anchoring system according to embodiments of the present invention.

FIG. 8B is a top view of the anchoring system of FIG. 8A.

FIG. 9A is a top perspective view of an alternative anchoring system according to embodiments of the present invention.

FIG. 9B is a top view of the anchoring system of FIG. 9A.

FIG. 10A is a top perspective view of the anchoring system of FIG. 9A adjusted to accommodate a larger diameter monopole.

FIG. 10B is a top view of the anchoring system of FIG. 10A.

FIG. 11A is a top perspective view of an alternative clamping member of the base module of the anchoring systems of the present invention.

FIG. 11B is a top view of an alternative anchoring system utilizing the clamping member of FIG. 11A according to embodiments of the present invention.

FIG. 12 is a front view of an anchoring system for a guyed antenna tower according to embodiments of the present invention.

FIG. 13A is a front perspective view of an alternative anchoring system for a guyed antenna tower according to embodiments of the present invention.

FIG. 13B is a front perspective view of a mounting bracket for the anchoring system of FIG. 13A.

FIG. 13C is a rear perspective view of the mounting bracket of FIG. 13B.

FIG. 14A is a bottom perspective view of an anchoring system for a cable ladder according to embodiments of the present invention.

FIG. 14B is a front view of the anchoring system of FIG. 14A.

FIG. 15A is an exemplary cable ladder on which the anchoring system of FIGS. 14A-14B may be utilized.

FIG. 15B is a partial view of the cable ladder of FIG. 15A without cables installed.

FIGS. 16A-16B are photographs of damaged cable ladders from the improper anchoring of hoisting grips and supported cables thereto.

FIG. 17A is a top perspective view of an alternative anchoring system for a ring mount according to embodiments of the present invention.

FIG. 17B is a perspective view of an exemplary use of the anchoring system of FIG. 17A.

FIG. 17C is a perspective view of the anchoring system of FIG. 17A illustrating different types and numbers of anchors that may be used according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer, or section. Thus, a first element, component, region, layer, or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for case of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

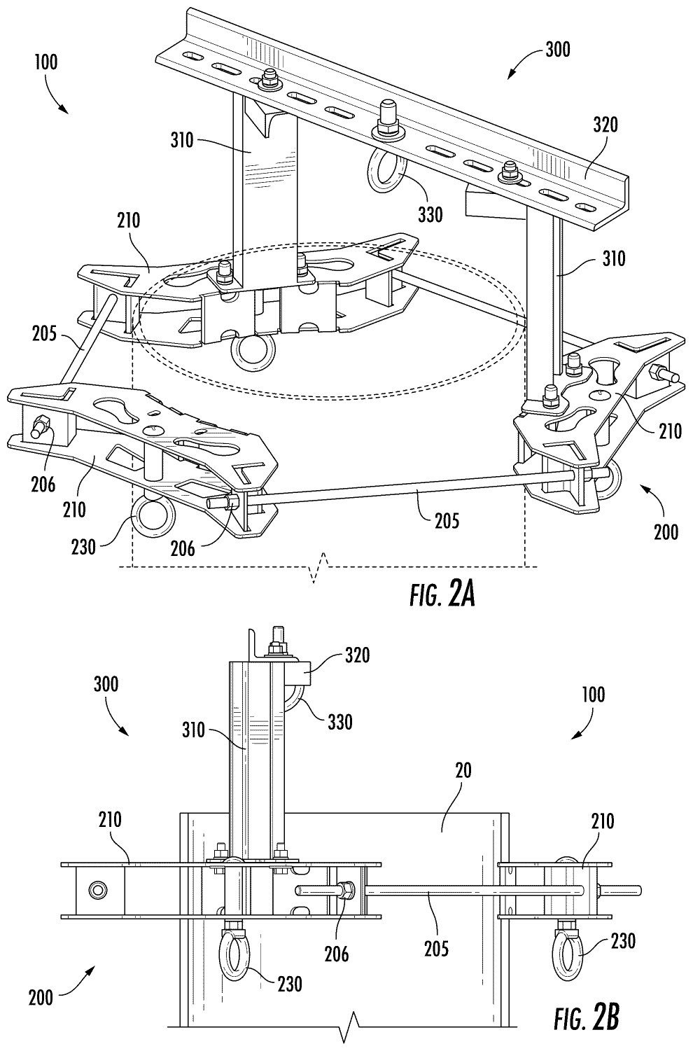

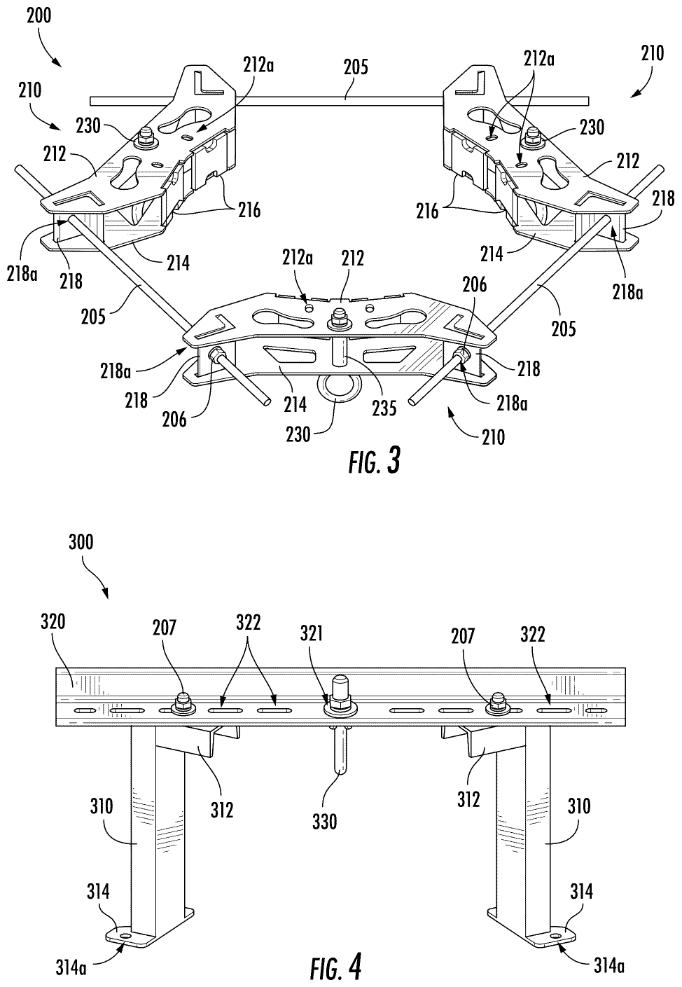

Embodiments of the present invention are directed to anchoring systems for cables (e.g., hoisting grips for cables) on a monopole. The anchoring systems provide increased strength and reliability compared to currently used anchoring systems (e.g., J-bolt anchors). In addition, the compact design of the anchoring systems has light volume and weight providing flexibility for installation. Further embodiments of the present invention are directed to anchoring systems for guyed antenna towers. Even further embodiments of the present invention are directed to anchoring systems for cable ladders extending up antenna masts. Embodiments of the present invention will now be described in further detail below with reference to FIGS. 2A-17C.

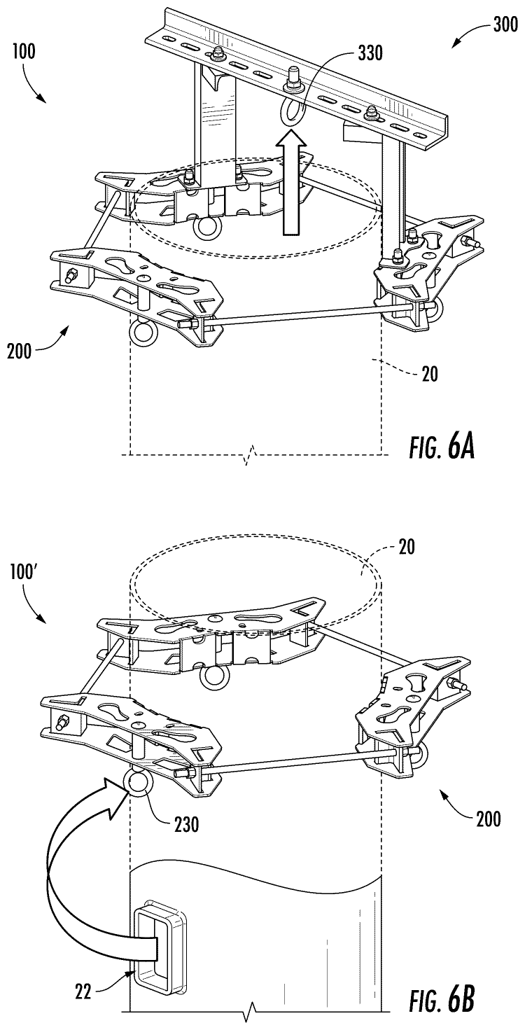

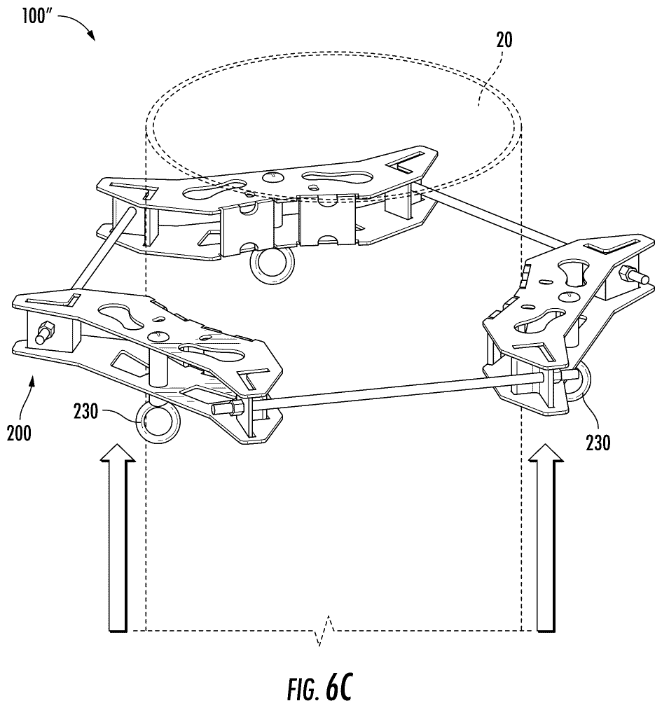

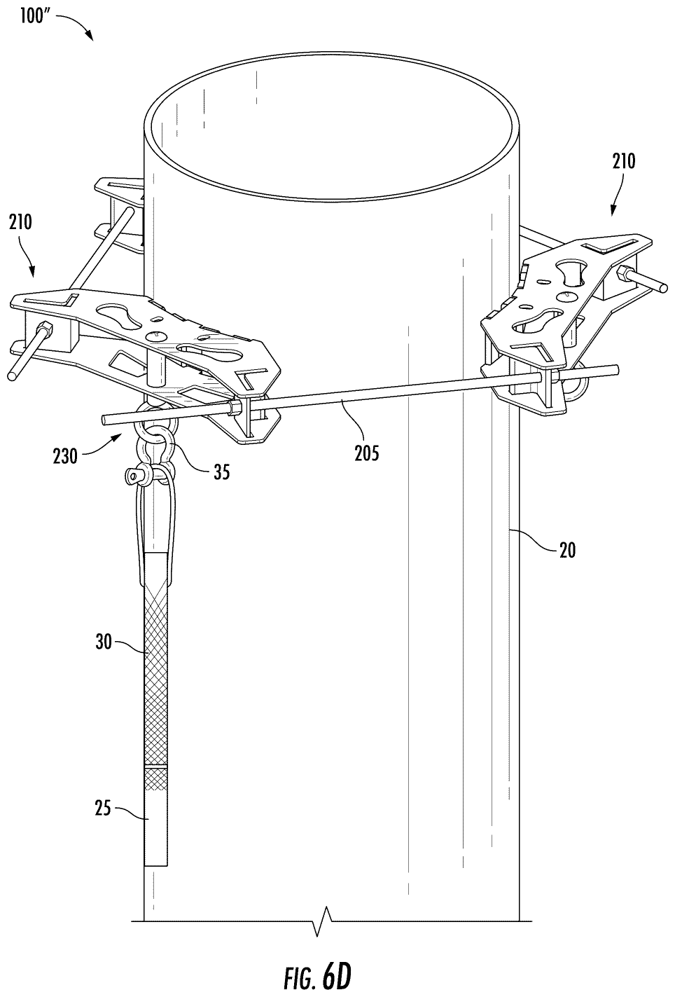

Referring to FIG. 2A-2B, an anchoring system 100 adapted for use on a monopole 20 according to embodiments of the present invention is illustrated. The anchoring system 100 may include a base module (e.g., a ring mount) 200 and an expansion module 300. In some embodiments, only the base module 200 of the anchoring system 100 may be needed, for example, when external cables 25 (often with hoisting grips 30, see, e.g., FIG. 6D) are secured directly to the anchoring system (see, e.g., FIG. 6B) or when internal cables 25 are routed out from a port or handhole 22 of the monopole 20 (see, e.g., FIG. 6C). The expansion module 300 may be used when internal cables 25 are routed out from the top of the monopole 20 (see, e.g., FIG. 6A).

As shown in FIGS. 2A-2B (see also FIG. 3), the base module 200 comprises a plurality of clamping or pressure members 210 where adjacent ones of the clamping members 210 are connected by threaded members 205 (e.g., threaded rods). In the illustrated embodiment, three clamping members 210 are used where each pair of the adjacent clamping members 210 are connected by a single threaded member 205 (see also, e.g., FIG. 3). The threaded members 205 engage with mating threaded connectors 206 (e.g., nuts) such that the threaded connectors 206 may be threaded onto and off of the threaded members 205 to decrease or increase the spacing between the clamping members 210. The monopole 20 is located inside of (between) the clamping members 210 such that the clamping members 210 may be tightened into engagement with the monopole 20 using threaded members 205 and threaded connectors 206 to secure the base module to the monopole 20. In addition, each clamping member 210 of the base module 200 comprises an eyebolt 230 affixed thereto. As described in further detail below, each eyebolt 230, 230′ is configured to engage one or more hoisting grips 30 that support cables 25 being routed inside and/or outside of the monopole 20 (see, e.g., FIGS. 6B-6D).

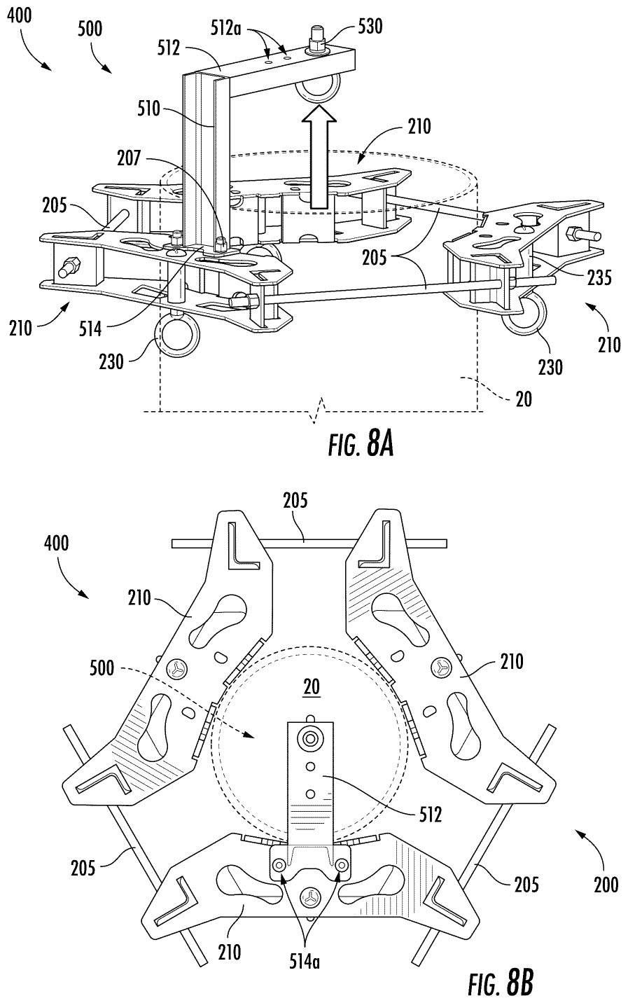

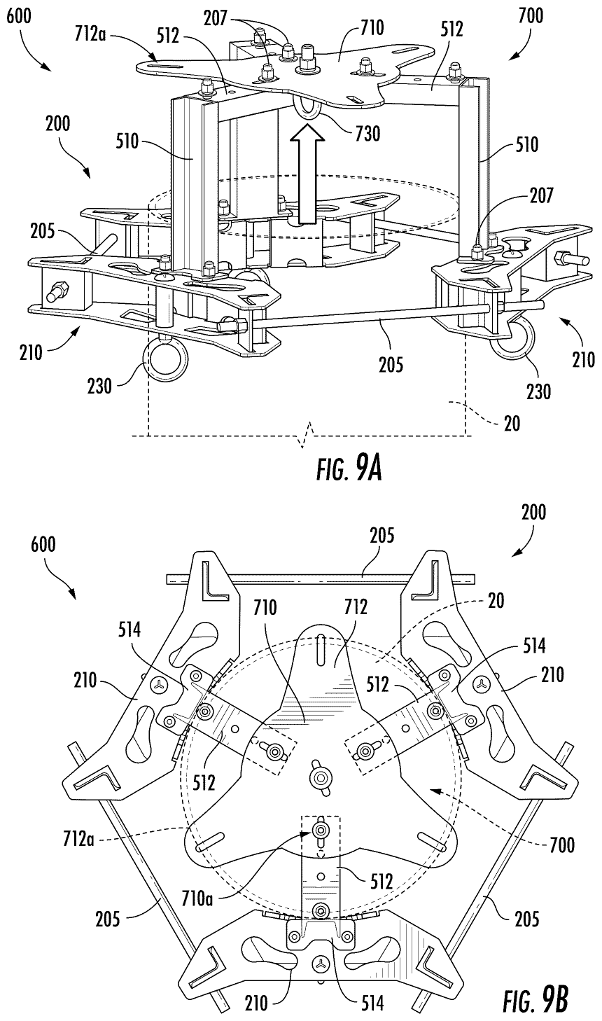

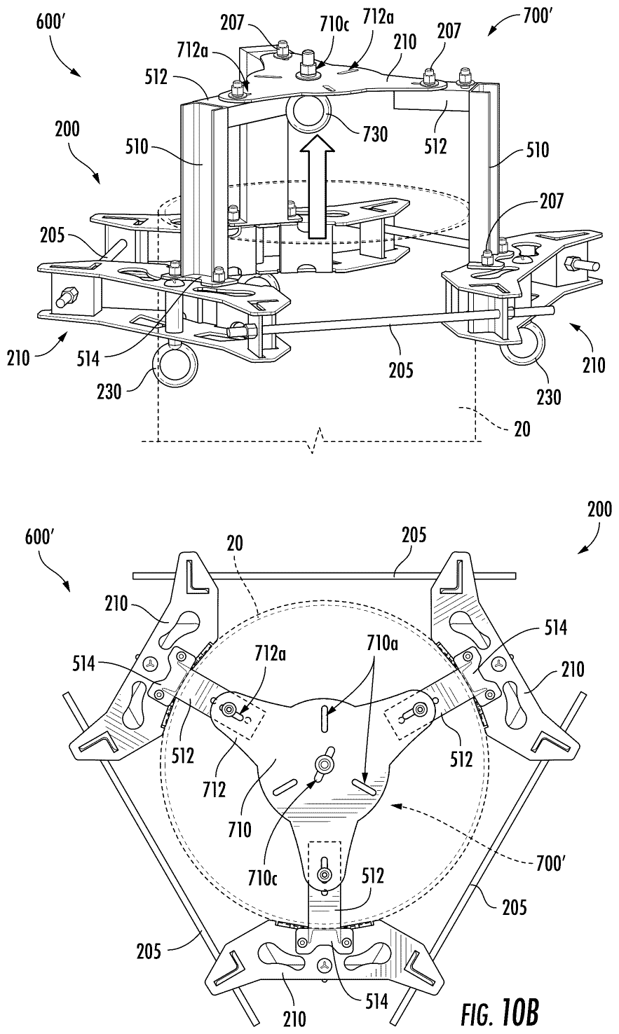

Referring to FIG. 3, the base module 200 of the present invention is illustrated, and will now be described in further detail. As shown in FIG. 3, each clamping member 210 includes an upper plate 212 and a lower plate 214. Each upper plate 212 comprises a plurality of apertures 212a. Some of the apertures 212a may be configured to receive a fastener 207 to secure the expansion member 300 to the base module 200 (see, e.g., FIG. 8A, FIG. 9A, FIG. 10A). Support beams 218 connect the upper plate 212 to the lower plate 214 and hold the plates 212, 214 in a spaced relationship. The support beams 218 may be connected to the upper plate 212 and the lower plate 214 using any suitable mechanism such as welding. Each of the support beams 218 have an aperture 218a configured to receive a threaded member 205.

In some embodiments, each clamping member 210 comprises one or more dispersement plates 216 that are configured to spread the load from the clamping member 210 over a wider area of the monopole 20 and/or to reduce the tilting of the clamping member 210 and related damage to the monopole 20. Each dispersement plate 216 is disposed between the points of contact of the upper and lower plates 212, 214 and the monopole 20. The disbursement plates 216 alleviate the local point stresses by distributing the load over a greater area of the monopole 20 than the narrow edges of the upper and lower plates 212, 214, respectively.

A hollow pipe 235 is secured (e.g., welded) between the upper and lower plates 212, 214 further coupling the upper plate 212 and lower plate 214 together. The hollow pipe 235 is configured to receive a portion of the shaft of a respective eyebolt 230, 230′ (see also, e.g., FIGS. 5A-5B). In addition, the pipe 235 provides structural support to the clamping member 210, thereby increasing the strength and reliability of the anchoring system 100.

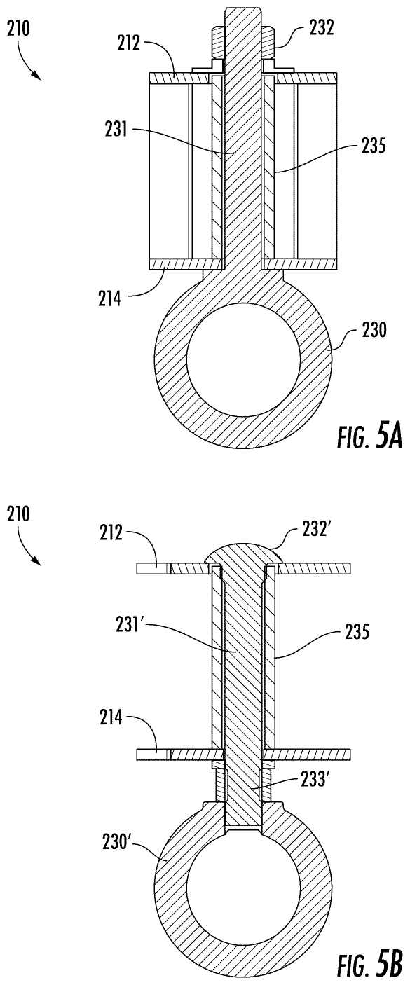

Referring to FIG. 4, the expansion module 300 of the present invention is illustrated, and will now be described in further detail. As shown in FIG. 4, the expansion module 300 includes a main support bracket 320 secured to pair of leg brackets 310. In some embodiments, the main support bracket 320 is an L-shaped bracket. The main support bracket 320 comprises a central aperture 321 and a plurality of elongated or oblong apertures 322. An eyebolt 330 is configured to be received by the central aperture 321 and secured to the main support bracket 320. The eyebolt 330 is configured to engage one or more hoisting grips 30 that support cables 25 being routed inside and/or outside of the monopole 20 (see, e.g., FIG. 6A and FIG. 6D).

Additional fasteners 207 are configured to be received through respective elongated apertures 322 to secure the main support bracket 320 to each of the leg brackets 310. As shown in FIG. 4, in some embodiments, the fasteners 207 secure the main support bracket 320 to a flange 312 extending outwardly from an upper segment of each leg bracket 310. Each leg bracket 310 further comprises one or more feet members 314 extending outwardly from a lower edge of each leg bracket 310. The feet members 314 each have a mounting aperture 314a configured to receive a respective fastener 207 to secure the expansion module 300 to a respective clamping member 210 of the base module 200, if needed (see, e.g., FIGS. 2A-2B, FIG. 6A and FIGS. 7A-7B).

FIGS. 5A-5B illustrate exemplary eyebolts 230, 230′ that may be used with the anchoring system 100 of the present invention. As shown in FIG. 5A, in some embodiments, the eyebolt 230 may comprise a shank 231 that is configured to be received through the hollow pipe 235 and secured to the clamping member 210 via a fastener 232 (e.g., a nut). As shown in FIG. 5B, in other embodiments, the eyebolt 230 may be replaced by a carriage bolt 230′ having a flanged hex head screw 232′. The carriage bolt 230′ is configured to be received through the hollow pipe 235 and fixed to an eye 234 by a fastening mechanism 233′ (e.g., a thread and thread-locking adhesives). The eyebolts 230, 230′ are configured to engage a fastener 35 to secure one or more hoisting grips 30 (and cables 25) to the anchoring system 100 (see, e.g., FIG. 6D).

FIGS. 6A-6D illustrate exemplary configurations for how the anchoring system 100 of the present invention may be used. The anchor system 100 of the present invention may be applicable to cable hoisting under any circumstance. As shown in FIGS. 6B-6D, the base module 200 may be used independently (i.e., without the expansion module 300) to fix hoisting grips and support cables being routed inside and outside of the monopole 20. For example, as shown in FIG. 6B, the base module 200 may be used for internal cables 25 routed out from a handhole or port 22 of the monopole 20 (as indicated by the arrow). As shown in FIG. 6C, the base module 200 may be used for external cables 25 routed directly (as indicated by the arrows) to the base module 200. As shown in FIG. 6D, in some embodiments, the hoisting grips 30 may be secured to the eyebolt 230, 230′ via a fastener 35 such as a pin and shackle bolt or the like. In addition, as shown in FIG. 6A, the anchor system 100 may be used for internal cables 25 routed out from the top of the monopole 20 (as indicated by the arrow) by adding the expansion module 300. Furthermore, in some embodiment, the anchoring system 100 of the present invention may be configured to withstand a maximum bearing load mass up to 6000 pounds (e.g., 2000 pounds×3 clamping members 210). Thus, in some embodiments, the anchoring system 100 of the present invention can hoist most antenna equipment in addition to the cables 25.

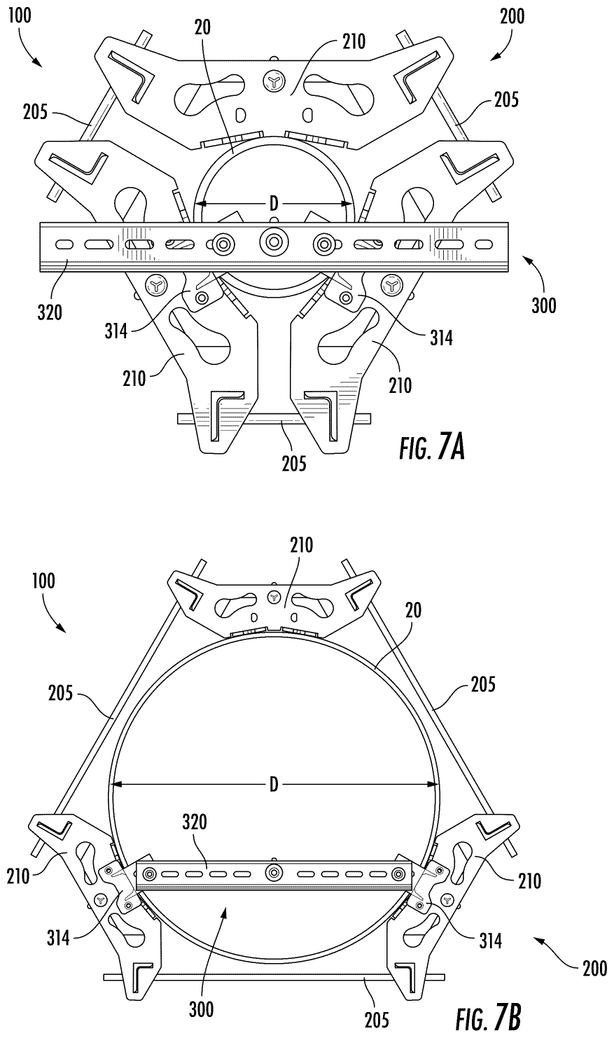

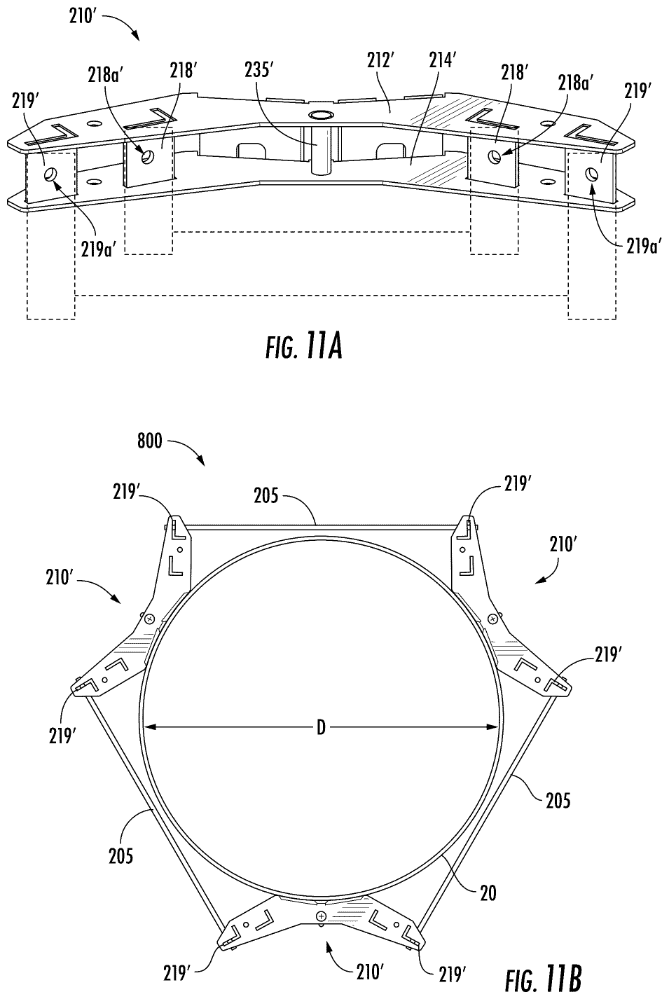

According to embodiments of the present invention, and illustrated in FIGS. 7A-7B, the anchoring system 100 may be adjustable to accommodate different diameter (D) monopoles 20. For example, in some embodiments, the anchoring system 100 may accommodate monopoles 20 having an outer diameter (D) in the range of about 10 inches to about 35 inches. In other embodiments, an anchoring system 800 of the present invention may be adjustable to accommodate monopoles 20 having an outer diameter (D) up to 55 inches (see, e.g., FIGS. 11A-11B).

Referring now to FIGS. 8A-10B, alternative anchoring systems 400, 600, 600′ according to embodiments of the present invention are illustrated. Properties and/or features of the anchoring systems bracket 400, 600, 600′ may be as described above in reference to the anchoring system 100 shown in FIGS. 2A-2B and FIGS. 6A-7B and duplicate discussion thereof may be omitted herein for the purposes of discussing FIGS. 8A-10B.

The anchoring systems 400, 600, 600′ each include the same or similar base module 200 as described herein with respect to anchoring system 100 (see, e.g., FIG. 3), but have different expansion modules 500, 700, 700′ that may be used to satisfy different customer requirements, for example, with respect to bearing load mass, monopole diameters, and/or hoisting methods. Similar to the expansion module 300 for anchoring system 100 described herein (see, e.g., FIG. 4), the expansion modules 500, 700, 700′ for anchoring systems 400, 600, 600′ are applicable for use for internal cables 25 routed out from the top of the monopole 20 (e.g., as illustrated in FIGS. 8A, 9A, and 10A).

Alternative anchoring system 400 according to embodiments of the present invention is illustrated in FIGS. 8A-8B. As shown in FIGS. 8A-8B, the expansion module 500 of anchoring system 400 includes an L-shaped bracket having a main member 510 and an arm member 512 coupled thereto. The main member 510 is configured to be secured to a clamping member 210 of the base module 200. Similar to the leg brackets 310 of the expansion module 300 described herein, in some embodiments, the main member 510 comprises a foot or flanged bottom edge 514 having one or more apertures 514a configured to receive respective fasteners 207 to secure the expansion module 500 to the apertures 212a in the upper plate 212 of a clamping member 210 of the base module 200.

The arm member 512 extends inwardly from the main member 510 such that the arm member 512 is positioned over at least a portion of the top of the monopole 20. The arm member 512 comprises one or more apertures 512a configured to receive an eyebolt 530. In some embodiments, the arm member 512 has more than one aperture 512a, thereby allowing the eyebolt 530 to be secured in different positions above the top of the monopole 20 (i.e., position the eyebolt 530 different distances from the main member 510). In addition, as discussed in further detail below and shown in FIGS. 9A-10B, the apertures 512a in the arm member 512 may also be configured to receive fasteners 207 such that an expansion plate 710 may be secured above the monopole 20, for example, as part of alternative anchoring systems 600, 600′ and corresponding expansion modules 700, 700′.

The eyebolt 530 used with expansion module 500 may be similar to the eyebolts 230, 230′, 330 described herein (see, e.g., FIGS. 5A-5B). In some embodiments, the anchoring system 400 and corresponding expansion module 500 may be used for light duty cables, and monopoles 20 having an outer diameter (D) in the range of about 10 inches to about 18 inches. “Light duty” cables typically refers to cables having a total weight not exceeding 650 pounds.

Referring now to FIGS. 9A-10B, alternative anchoring systems 600, 600′ according to embodiments of the present invention are illustrated. As shown in FIGS. 9A-10B, the expansion modules 700, 700′ include three (3) of the expansion modules 500 described herein, each expansion module 500 secured to a respective clamping member 210 of the base module 200. As noted above, the expansion modules 700, 700′ further include an expansion plate 710. As shown in FIGS. 9B and 10B, the expansion plate 710 has a generally circular shape with three spaced-apart arms 712 extending radially outwardly therefrom. Each of the arms 712 comprises an outer slot 712a configured to receive a fastener 207. The expansion plate 710 comprises a central aperture 710c configured to receive an eyebolt 730. The eyebolt 730 used with expansion modules 700, 700′ may be similar to the eyebolts 230, 230′, 330, 530 described herein (see, e.g., FIGS. 5A-5B). In some embodiments, the anchoring system 600, 600′ and corresponding expansion module 700, 700′ may be used for heavy duty cables. “Heavy duty” cables typically refers to cables having a total weight not exceeding 1800 pounds.

The expansion plate 710 further comprises three inner slots 710a which are also configured to receive a fastener 207. As shown in FIGS. 9A-10B, each of the inner slots 710a is positioned between each adjacent arms 712 and radially inward from each of the outer slots 712a in the arms 712 of the expansion plate 710. The positions of the inner and outer slots 710a, 712a with respect to each other allow the anchoring systems 600, 600′ to accommodate different diameter monopoles 20. For example, as shown in FIGS. 9A-9B, the expansion plate 710 is positioned and secured to the expansion modules 500 via fasteners 207 received through respective inner slots 710a in the expansion plate 710. This allows the anchoring system 600 to accommodate monopoles 20 having an outer diameter (D) in a range of about 19 inches to about 25 inches. Compared to the anchoring system 600′ shown in FIGS. 10A-10B in which the expansion plate 710 is rotated and secured to the expansion modules 500 via fasteners 207 received through respective outer slots 712a in the arms 712 of the expansion plate 710. This allows the anchoring system 600′ to accommodate monopoles 20 having an outer diameter (D) in a range of about 25inches to about 35 inches.

Referring to FIGS. 11A-11B, in some embodiments, the clamping members 210′ may be modified to accommodate larger diameter monopoles 20, for example, monopoles 20 having an outer diameter up to 55 inches. As shown in FIG. 11A, the modified clamping members 210′ have four support beams, two inner support beams 218′ and two outer support beams 219′. Similar to the support beams 218 described herein, the support beams 218′, 219′ connect the upper plate 212′ to the lower plate 214′ and hold the plates 212′, 214′ in a spaced relationship. The support beams 218′, 219′ may be connected to the upper plate 212′ and the lower plate 214′ using any suitable mechanism such as welding. In addition, each of the support beams 218′, 219′ have respective apertures 218a′, 219a′ configured to receive a threaded member 205. The threaded members 205 are inserted through the apertures 218a′ in the inner support beams 218′ for monopoles 20 having an outer diameter in the range of between about 10 inches and about 33 inches. As shown in FIG. 11B, for larger diameter monopoles 20, for example, for monopoles 20 having an outer diameter in the range of between about 34 inches and about 55 inches, the threaded members 205 are inserted through the apertures 219a′ in the outer support beams 219′ of each clamping member 210′.

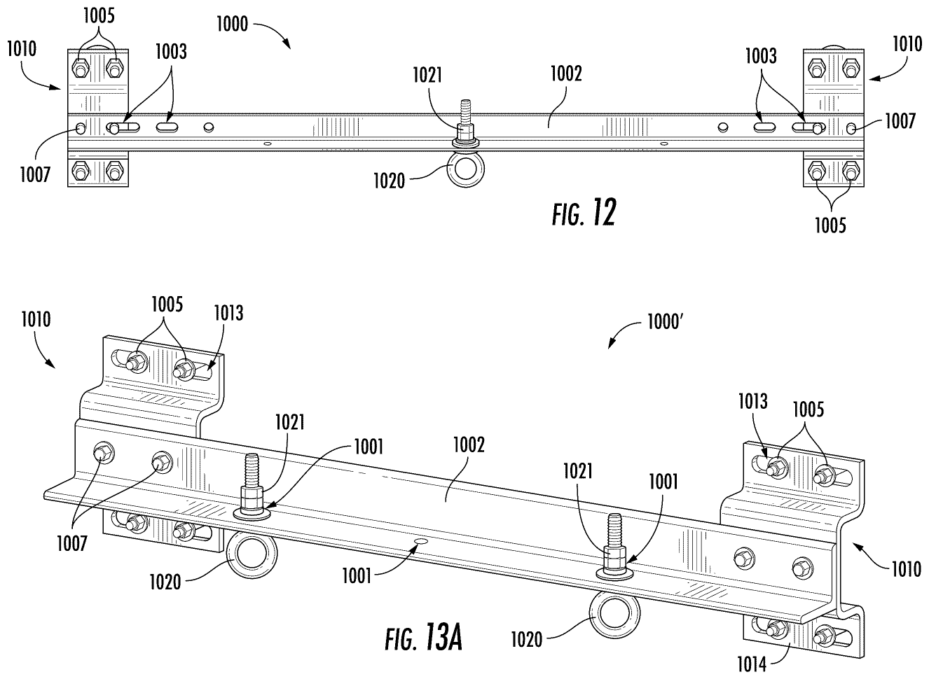

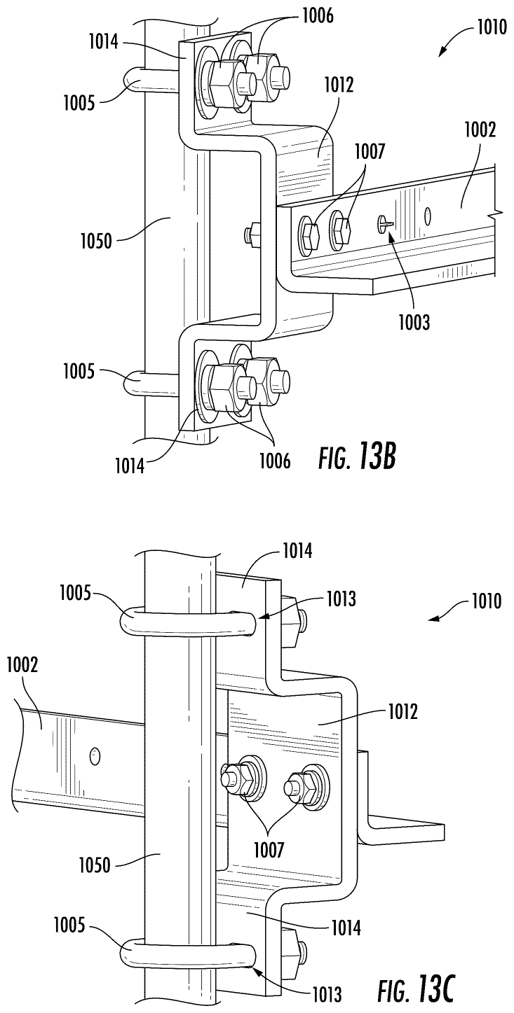

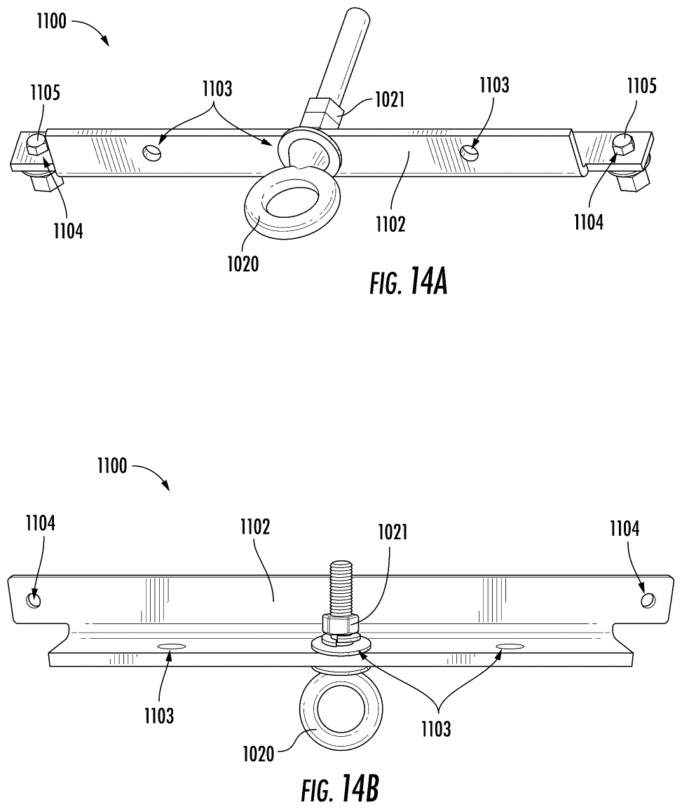

Referring to FIG. 12 and FIGS. 13A-13C, anchoring systems 1000, 1000′ for guyed antenna towers according to embodiments of the present invention are illustrated. As shown in FIG. 12 and FIGS. 13A-13C, the anchoring systems 1000, 1000′ include a main support beam 1002. As shown in FIGS. 13A-13C, in some embodiments, the main support beam 1002 may be an L-shape beam.

The anchoring systems 1000, 1000′ further include mounting brackets 1010 coupled to opposing ends of the main support beam 1002. As shown in FIGS. 13B-13C, the mounting brackets 1010 are configured to secure the anchoring systems 1000, 1000′ to a leg or other structure 1050 of the guyed antenna tower. For example, in some embodiments, each mounting bracket 1010 comprises a main body 1012 having opposing flanged ends 1014. Each flanged end 1014 has a pair of apertures or elongated slots 1013 that are configured to receive a fastener 1005 (e.g., a U-bolt) and securing component 1006 (e.g., nuts) which engage and secure the respective mounting bracket 1010 to the leg or other structure 1050 of the guyed antenna tower (see, e.g., FIGS. 13B-13C).

As shown in FIG. 12 and FIGS. 13A-13C, the main support beam 1002 comprises a plurality of apertures and/or elongated slots 1001, 1003. In some embodiments, the mounting brackets 1010 are secured to the main support beam 1002 via fasteners (e.g., bolts) 1007 received through apertures or elongated slots 1003 in the main support beam 1002. The apertures or elongated slots 1003 allow the mounting brackets 1010 to be adjustably secured along a length of the main support beam 1002 such that the anchoring systems 1000, 1000′ may accommodate different mounting configurations (e.g., spacing between legs or other structures 1050) on the guyed antenna tower.

The anchoring systems 1000, 1000′ further comprise one or more eyebolts 1020 affixed to the main support beam 1002. For example, anchoring system 1000 comprises one eyebolt 1020 and anchoring system 1000′ comprises two eyebolts 1020. In other embodiments, the anchoring systems 1000, 1000′ may comprise more than two eyebolts 1020. The eyebolts 1020 used with anchoring systems 1000, 1000′ may be similar to the eyebolts 230, 230′, 330, 530, 730 described herein (see also, e.g., FIGS. 5A-5B). In some embodiments as shown in FIG. 12 and FIG. 13A, the eyebolts 1020 may be received through apertures 1001 in the main support beam 1002 and secured thereto with securing components (e.g., washers and nuts) 1021. The eyebolts 1020 are configured to engage one or more hoisting grips 30 that support cables 25 being routed up the guyed antenna tower.

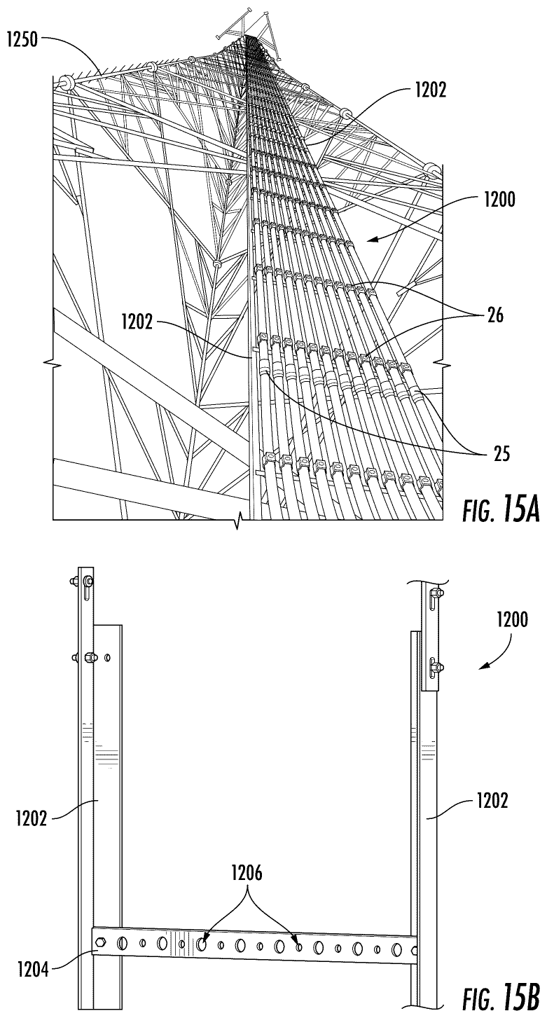

Referring now to FIGS. 14A-14B, an anchoring system 1100 for use on a cable ladder 1200 (see, e.g., FIGS. 15A-15B) according to embodiments of the present invention is illustrated. As shown in FIGS. 14A-14B, similar to the anchoring systems 1000, 1000′ for the guyed antenna tower described herein, the anchoring system 1100 for the cable ladder 1200 includes a main support beam 1102 having a plurality of apertures 1103, 1104. As shown in FIG. 14B, in some embodiments, the main support beam 1102 may be an L-shaped beam.

The anchoring system 1100 further includes one or more eyebolts 1020. The eyebolt 1020 is the same eyebolt 1020 used with anchoring systems 1000, 1000′ but also may be similar to the eyebolts 230, 230′, 330, 530, 730 described herein (see also, e.g., FIGS. 5A-5B). As shown in FIGS. 14A-14B, the eyebolt 1020 may be received through one of the apertures 1103 in the main support beam 1102 and secured thereto with securing components (e.g., washers and nuts) 1021.

FIGS. 15A-15B illustrate an exemplary cable ladder 1200 on which the anchoring system 1100 of the present invention may be used. As shown in FIG. 15A, the cable ladder 1200 extends up an antenna mast 1250 and is configured to support cables 25 being routed to the top of the antenna mast 1250. As shown in FIG. 15B, the cable ladder 1200 may comprise a pair of support beams 1202 extending parallel with each and having a plurality of cable beams 1204 extending therebetween. Each of the cable beams 1204 comprise a plurality of apertures 1206 configured to receive and secure cable hangers 26 thereto. The cable hangers 26 grip and secure the cables 25 being routed up the antenna mast 1250.

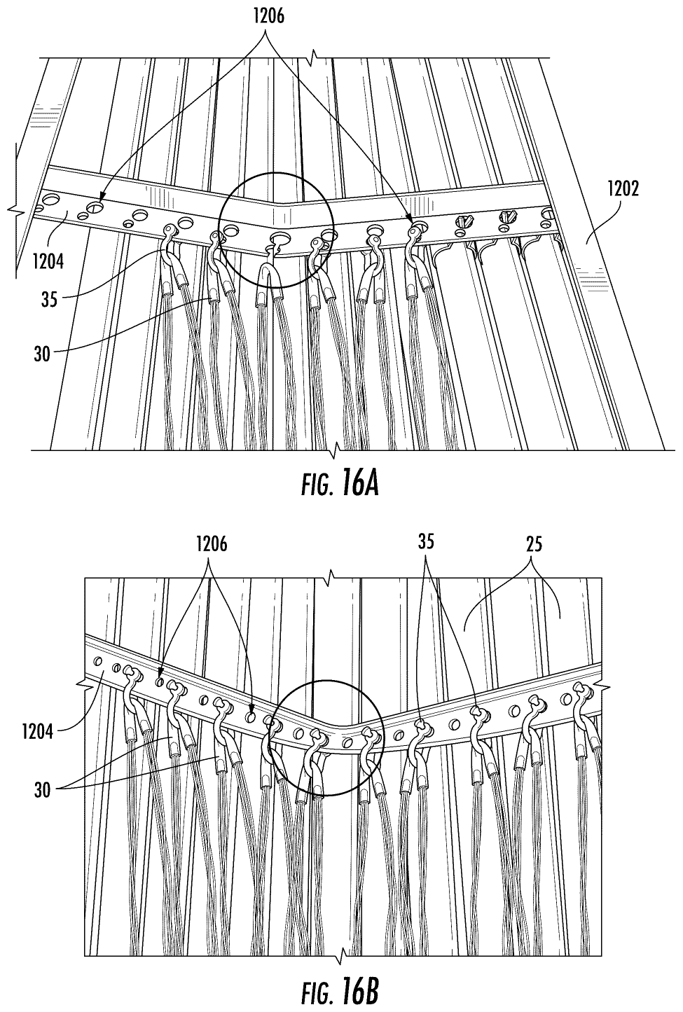

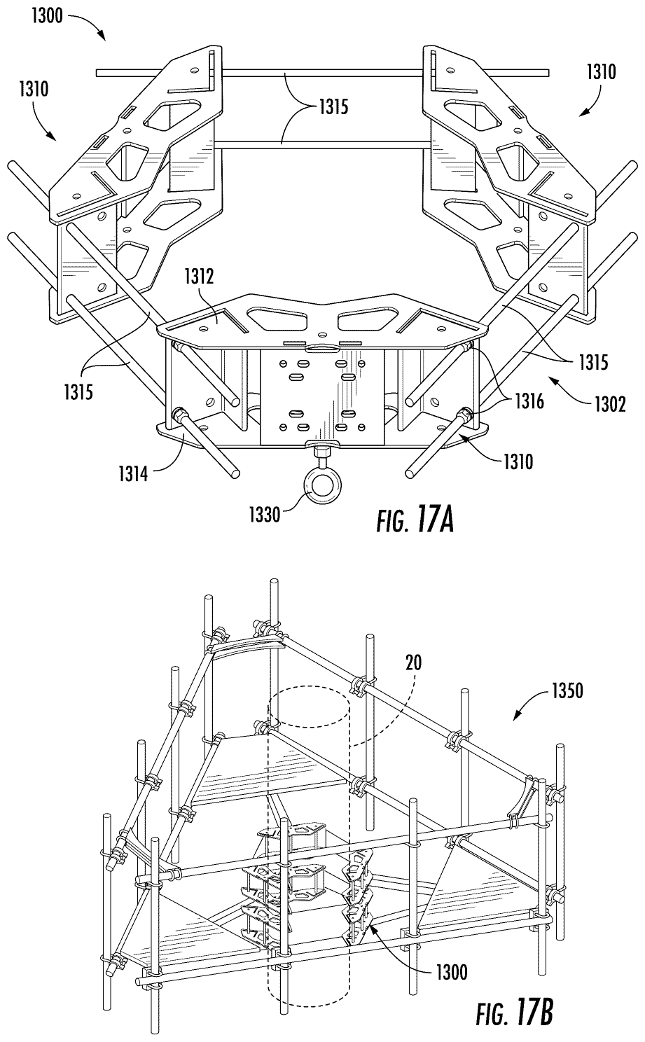

As shown in FIGS. 16A-16B, in some instances in the field, the apertures 1206 in the cable beams 1204 are being improperly used to secure the fasteners 35 holding one or more hoisting grips 30 (and cables 25) to the cable ladder 1200. However, the cable beams 1204 are not configured to support the load weight of these hoisting grips 30 (and cables 25), thereby causing damage to the cable ladder 1200 (buckling of the cable beams 1202 is circled in FIGS. 16A-16B).

Referring back to FIGS. 14A-14B, the apertures 1104 in the main support beam 1102 of the anchoring system 1100 are configured to align with respective apertures 1206 in the cable beams 1204 of the cable ladder 1200 in order to secure the anchoring system 1100 to the cable ladder 1200 (e.g., via fasteners). The eyebolts 1020 are configured to engage one or more hoisting grips 30 that support cables 25 being routed up the antenna mast. The anchoring system 1100 (i.e., eyebolt 1020) is configured to support the load weight of the hoisting grips 30 (and cables 25) without causing damage to the cable ladder 1200.

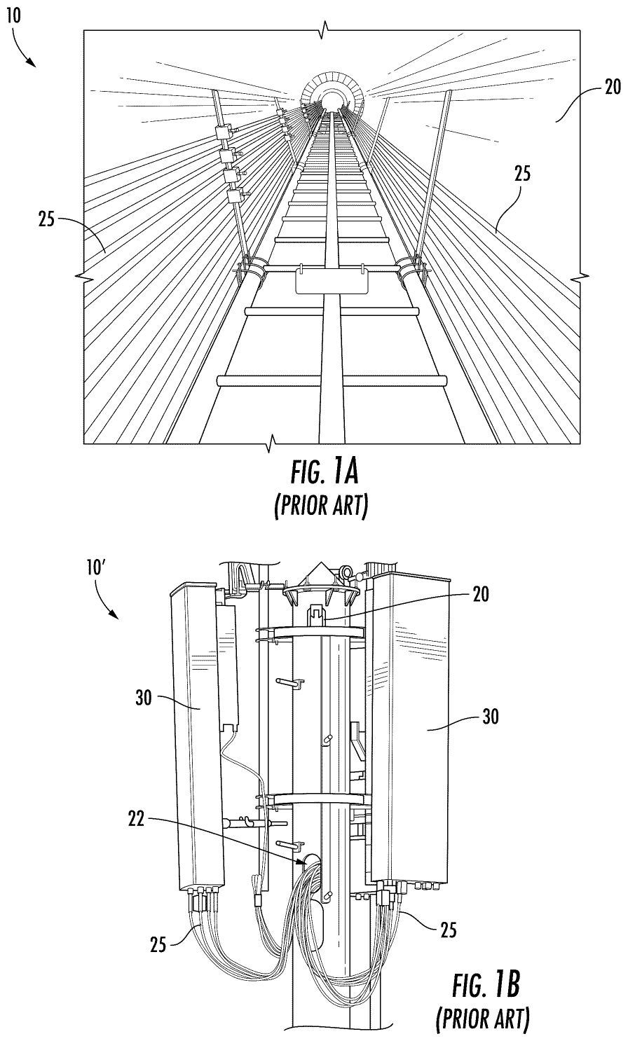

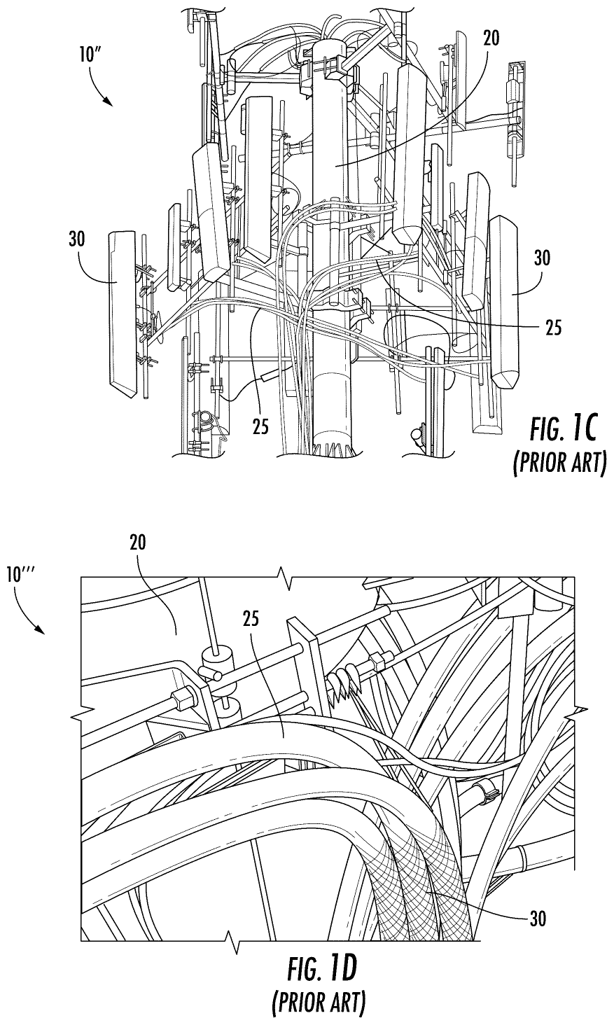

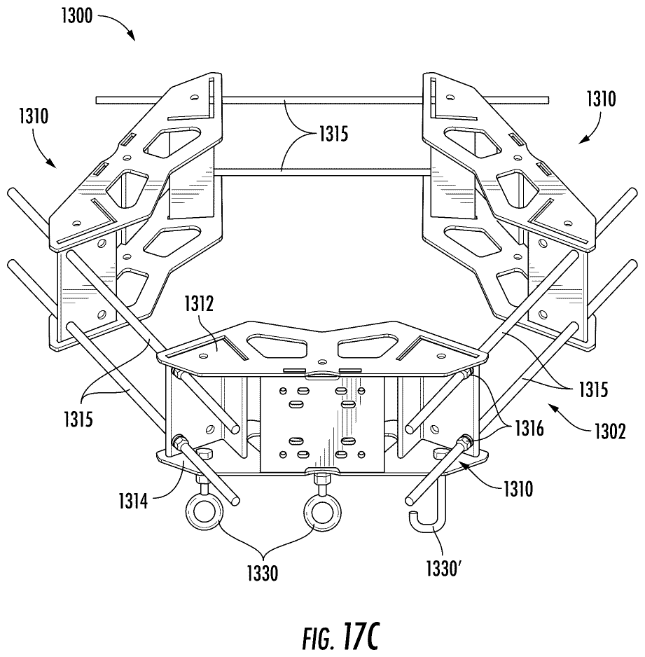

Referring now to FIGS. 17A-17C, an alternative anchoring system 1300 is illustrated. As shown in FIG. 17A and FIG. 17C, the anchoring system 1300 includes a ring mount 1302. In some instances, ring mounts are currently being improperly used as anchoring systems on monopoles (see, e.g., FIG. 1D). In some embodiments, the ring mount 1302 for anchoring system 1300 may be similar to other ring mounts (i.e., base modules 200) described herein. For example, in some embodiments, the ring mount 1302 may include a plurality of clamping or pressure members 1310 where adjacent ones of the clamping members 1310 are connected by threaded members 1315 (e.g., threaded rods). In the illustrated embodiment, three clamping members 1310 are used such that each pair of the adjacent clamping members 1310 is connected by a pair of threaded member 1315. A mounting structure (e.g., a monopole 20) is positioned inside of (between) the clamping members 1310 such that the clamping members 1310 may be tightened into engagement with the mounting structure using threaded members 1315 and threaded connectors 1316 to secure the ring mount 1302 to the mounting structure.

In addition, each clamping member 1310 of the ring mount 1302 may include one or more anchor members 1330, 1330′ affixed thereto. For example, in some embodiments, as shown in FIG. 17C, multiple anchor members 1330, 1330′ may be affixed to the clamping member 1310. In some embodiments, the anchor members 1330, 1330′ may be an eyebolt 1330 (see, e.g., FIGS. 17A and 17C). The eyebolts 1330 may be similar to any of the eyebolts 230, 230′, 330, 530, 730, 1020 described herein. In other embodiments, the anchor members 1330, 1330′ may be a hook 1330′ or other type of fastener/bracket mechanism. The anchor members 1330, 1330′ may all be the same type (e.g., all eyebolts 1330) or different types (e.g., eyebolts 1330 and hooks or other fasteners 1330′) may be affixed to the same clamping member 1310.

In some embodiments, each clamping member 1310 of the ring mount 1302 comprises an upper plate 1312 and a lower plate 1314. As shown in FIG. 17A, in some embodiments, the anchor member 1330 may be coupled or affixed to the lower plate 1314 of the respective clamping member 1310. In some embodiments, the anchor member 1330 may be coupled or affixed to the clamping member 1310 in similar manners described herein (see, e.g., eyebolts 210, 210′ illustrated in FIGS. 5A-5B).

In addition to being configured to engage one or more hoisting grips 30 that support cables 25 (see, e.g., FIG. 6D), in some embodiments, anchoring system 1300 may be configured to attach a monopole platform 1340 to the face of the monopole 20 (see, e.g., FIG. 17B). In some embodiments, the anchoring system 1300 may also be configured to secure equipment (e.g., telecommunications equipment).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed is:

1. An anchoring system for cables on a monopole, the anchoring system comprising:
a base module comprising a plurality of clamping members, each clamping member comprising:
an upper plate having a plurality of apertures;
a lower plate coupled to the upper plate by two or more support beams, each support beam having an aperture configured to receive a threaded member; and
a hollow pipe secured between the upper and lower plates, wherein at least a portion of an eyebolt is received through the hollow pipe and secured to the clamping member,
wherein adjacent clamping members are connected by the threaded members that engage with mating threaded connectors such that the threaded connectors may be threaded onto and off of the threaded members to decrease or increase spacing between the clamping members to engage the monopole therebetween, and
wherein each eyebolt is configured to engage one or more hoisting grips that support cables being routed inside and/or outside of the monopole.

2. The anchoring system according to claim 1, wherein the one or more hoisting grips support cables routed outside of the monopole.

3. The anchoring system according to claim 1, wherein the one or more hoisting grips support cables routed out from a port or handhole of the monopole.

4. The anchoring system according to claim 1, wherein the base module comprises three clamping members, wherein each pair of the adjacent clamping members are connected by a single threaded member.

5. The anchoring system according to claim 1, wherein the two or more support beams hold the upper and lower plates in a spaced relationship.

6. The anchoring system according to claim 1, wherein each clamping member further comprises one or more dispersement plates coupled to the upper and lower plates, each dispersement plate is disposed between points of contact of the upper and lower plates and the monopole and are configured to spread a load applied from the clamping member over a wider area of the monopole when the clamping member is engaged with the monopole.

7. The anchoring system of according to claim 1, further comprising an expansion module coupled to the base module, wherein one or more of the plurality of apertures in the upper plate of a clamping member are configured to receive a fastener to secure the expansion module to the base module, and wherein the expansion module comprises:
a main support bracket having a central aperture and a plurality of elongated apertures;
a pair of leg brackets secured to the main support bracket by fasteners received through respective elongated apertures, wherein each leg bracket is configured to be secured to a respective clamping member of the base module; and
an eyebolt received by the central aperture and secure to the main support bracket, the eyebolt configured to engage one or more hoisting grips that support cables being routed from out of a top of the monopole.

8. The anchoring system according to claim 7, wherein the expansion module comprises an L-shaped bracket having a main member and an arm member coupled thereto and extending inwardly from the main member such that the arm member is positioned over a top of the monopole, the main member is configured to be secured to a clamping member of the base module and the arm member has one or more apertures with an eyebolt received through one of the apertures and secured thereto.

9. The anchoring system according to claim 7, wherein the expansion module comprises three L-shaped brackets and an expansion plate, each L-shaped bracket has a main member and an arm member coupled thereto and extending inwardly from the main member such that each of the arm members are positioned over a top of the monopole, each main member is configured to be secured to a respective clamping member of the base module and each arm member is configured to be secured to the expansion plate, the expansion plate comprising a central aperture with an eyebolt received therethrough and secured to the expansion plate.

10. The anchoring system according to claim 9, wherein the expansion plate has a generally circular shape with three spaced-apart arms extending radially outwardly therefrom, and wherein each of the arms comprise an outer slot and the expansion plate comprises three inner slots positioned between each adjacent arm and radially inward from each of the outer slots, each of the inner and outer slots configured to receive a fastener to secure the expansion plate to the respective arms of the L-shaped brackets and the position of the slots allows the anchoring system to accommodate different diameter monopoles.

11. The anchoring system according to claim 1, wherein the eyebolts each comprise a shank or a carriage bolt having a flanged hex head screw.

12. The anchoring system according to claim 1, wherein the clamping members comprise two inner support beams and two outer support beams, each of the support beams having respective apertures configured to receive a threaded member, the anchoring system configured to be adjustable to accommodate monopoles having a diameter up to 55 inches.

13. A cable anchoring system, the anchoring system comprising:
a main support beam;
two mounting brackets, each mounting bracket affixed to an opposing end of the main support beam, the mounting brackets configured to secure the anchoring system to a guyed antenna tower; and
at least one eyebolt affixed to the main support beam,
wherein the at least one eyebolt is configured to engage one or more hoisting grips that support cables being routed up the guyed antenna tower.

14. The cable anchoring system according to claim 13, wherein the main support beam is L-shaped.

15. The cable anchoring system according to claim 13, wherein each mounting bracket comprises a main body having opposing flanged ends, each flanged end has a pair of apertures or elongated slots configured to receive a fastener to secure the mounting bracket to a structure of the guyed antenna tower.

16. The cable anchoring system according to claim 13, wherein the main support beam comprises a plurality of elongated slots which allow the mounting brackets to be adjustably secured along a length of the main support beam to accommodate different mounting configures on the guyed antenna tower.

17. A cable anchoring system for a cable ladder, wherein the cable ladder extends up an antenna mast and comprises a pair of support beams extending parallel to each other and having a plurality of cable beams extending therebetween, the cable anchoring system comprising:
a main support beam comprising at least two apertures which each align with a respective aperture in one of the plurality of cable beams; and
at least one eyebolt affixed to the main support beam,
wherein the aligned apertures are configured to receive a respective fastener to secure the anchoring system to the cable ladder, and
wherein the at least one eyebolt is configured to engage one or more hoisting grips that support cables being routed up the antenna mast.

18. The cable anchoring system according to claim 17, wherein the anchoring system is configured to support the load weight of the one or more hoisting grips and corresponding cables without causing damage to the cable ladder.

19. A cable anchoring system, the anchoring system comprising:
a base module comprising a plurality of clamping members, each clamping member comprising an upper plate and a lower plate, wherein adjacent clamping members are connected by threaded members configured to decrease or increase spacing between the clamping members to engage a mounting structure; and
one or more anchoring members coupled to the lower plate of at least one of the clamping members,
wherein the base module is configured to secure a platform assembly to the mounting structure.

20. The cable anchoring system of claim 10, wherein the mounting structure is a monopole, and wherein the anchoring system is configured to attach the platform assembly to the face of the monopole.
